(19) United States
(12) Patent Application Publication
(10) Pub. No.: US 2023/0250561 A1
(43) Pub. Date: Aug. 10, 2023

(54) Roller and Crosslapper and Carding Machine Comprising the Roller

(71) Applicant: Oskar Dilo Maschinenfabrik KG, Eberbach (DE)

(72) Inventor: Johann Philipp Dilo, Eberbach (DE)

(73) Assignee: Oskar Dilo Maschinenfabrik KG, Eberbach (DE)

(21) Appl. No.: 18/103,914

(22) Filed: Jan. 31, 2023

(30) Foreign Application Priority Data
Feb. 7, 2022 (EP) 22 155 418.1
Dec. 12, 2022 (EP) 22 213 472.8

(51) Int. Cl. D01G 15/18; B65H 27/00; D04H 1/74; D01G 15/04

(52) U.S. Cl. CPC D01G 15/18; B65H 27/00; D04H 1/74; D01G 15/04; B65H 2401/112; B65H 2404/10; B65H 2404/551

(57) ABSTRACT

The roller comprises a covering layer made of a fibre composite material and a cylindrical roller main body having an outer first lateral surface, a first end section and a second end section. The covering layer completely surrounds the first lateral surface in the circumferential direction. A first edge region of the covering layer extends beyond the first end section, is folded over inwards and is fixed in relation to the roller main body. In a crosslapper, the roller can be provided as a deflection roller of a conveyor belt. In a carding machine, the roller can be provided as an engagement roller for engagement with fibre material.

### BACKGROUND OF THE INVENTION

The present invention relates to a roller and to a crosslapper and a carding machine comprising the roller.

Rollers are used in many machines and devices for processing materials or guiding transport means, such as, for example, conveyor belts, and are generally subjected to high requirements in this context. Rollers which are used, for example, in the production of nonwovens in crosslappers or in carding machines must, on the one hand, be configured to be resistant to bending, but should have low rotating masses. Such rollers, made, for example, of aluminium, are relatively light, but have a low modulus of elasticity. If, on the other hand, the rollers are made of steel, they do have a high modulus of elasticity, but this is combined with a high mass. Another known practice is to form the roller body of the rollers from carbon fibre-reinforced plastic, such rollers being relatively light and resistant to bending but leading to very high acquisition costs in comparison with conventional solutions.

### SUMMARY OF THE INVENTION

According to an aspect of the invention, a roller, in particular for conveying and/or processing fibrous webs, preliminary batts, batts, nonwovens or nonwoven materials, in particular for use in a crosslapper or a carding machine, comprises a substantially cylindrical roller main body and a covering layer made of a fibre composite material. The roller main body has an outer first lateral surface, a first end section and a second end section, which lies opposite the first end section in the longitudinal direction of the roller main body, which corresponds to the axial direction of the roller main body. The covering layer completely surrounds the first lateral surface of the roller main body in the circumferential direction of the roller main body. A first edge region of the covering layer extends beyond the first end section of the roller main body, is folded over inwards and is fixed in relation to the roller main body.

In this way, a roller is provided which, by virtue of the covering layer made of fibre composite material, has a high resistance to bending and a low mass. However, the roller main body enables the proportion of fibre composite material to be reduced, thus making it possible to produce the roller at relatively low cost. The covering layer made of fibre composite material has a high modulus of elasticity with a low mass. The roller main body can be formed from a more favourable material, such as aluminium or steel, thus reducing costs when compared with a roller, the roller body of which consists entirely of fibre composite material.

Between the location of manufacture and the location of use as well as during the transport of the roller, the roller may be exposed to severe temperature fluctuations, for example of up to 30 Kelvin. Because of the significantly different temperature coefficients of the materials, there is the risk that such temperature fluctuations will lead to delamination of the covering layer from the roller main body. In the present case, this is prevented by folding the first edge region of the covering layer over inwards and fixing it there in relation to the roller main body. The covering layer made of fibre composite material has a lower temperature coefficient than the roller main body and, by virtue of its arrangement around the roller main body and around the end section thereof, prevents the roller main body from expanding both in the radial and in the axial direction.

The covering layer at least partially and preferably completely covers the first lateral surface. In a particularly preferred embodiment, a second edge region of the covering layer extends beyond the second end section of the roller main body, is folded over inwards and is fixed in relation to the roller main body. As a result, the covering layer is fixed symmetrically on the roller main body and is connected thereto in a particularly reliable manner.

Particularly as regards the roller main body and the covering layer, the roller is preferably formed both rotationally symmetrically with respect to a longitudinal axis of the roller and symmetrically with respect to a central plane of the roller or of the roller main body, the central plane being defined perpendicularly to the longitudinal axis between the two opposite ends of the roller main body.

Features of the roller are described below with reference to the first end section of the roller main body and the first edge region of the covering layer. There is a preference in each case for the second end section of the roller main body and the second edge region of the covering layer to be of analogous design. In principle, however, the first and the second end section or the first and the second edge region could also be of different designs.

The roller main body preferably forms a winding core around which the covering layer is laid. The covering layer can comprise a non-crimp fabric or a woven fabric of fibres, for example of carbon fibres. The covering layer can be single-ply or multi-ply.

Preferably, a first portion of fibres of the fibre composite material of the covering layer runs substantially in the circumferential direction of the roller main body and a second portion of fibres of the fibre composite material of the covering layer runs substantially in the longitudinal direction of the roller main body. This enables the covering layer to counteract expansion of the roller main body, both in the radial direction and in the longitudinal direction. It is self-evident that the first portion of fibres and the second portion of fibres can also run obliquely with respect to the circumferential direction or the longitudinal direction, wherein the first portion of fibres preferably extends completely around the circumference of the roller main body and the second portion of fibres extends completely from the first edge region to the second edge region of the covering layer.

In the first end section of the roller main body, the covering layer rests against the first lateral surface of the roller main body. The first edge region of the covering layer extends beyond the first lateral surface or the first end section and then extends inwards in the direction of the longitudinal axis of the roller main body.

The roller main body is preferably of tubular shape, at least in the first end section of the roller main body, and the first edge region of the covering layer is folded over around the first end section to such an extent that it is arranged in the interior of the first end section. Similarly, the second end section of the roller main body can be of tubular shape and the second edge region of the covering layer is folded over around the first end section to such an extent that it is arranged in the interior of the second end section. Tubular means that a substantially rotationally symmetrical recess extends in the longitudinal direction into the roller main body from the respective end of the roller main body.

In a particularly preferred embodiment, the roller main body is configured as a hollow shaft, thereby making it possible to further reduce the mass of the roller main body. In order to keep the costs low, the first and the second edge region are furthermore arranged and fixed in the first or second end section of the roller main body. The first and the second edge region are defined at a first and second circumferential edge, respectively, of the covering layer. That is to say that the covering layer ends at these edges and does not extend through the inside of the roller main body and that the fibres are not also wound in the longitudinal direction around the roller main body.

In order to produce a secure connection to the roller main body, the first edge region is preferably fixed adhesively and/or frictionally. The second edge region is also preferably fixed adhesively and/or frictionally. A frictional connection can be produced, for example, by means of a clamping element, which is described in detail below.

An adhesive connection can be provided by an adhesive or a resin used for laminating the fibre composite material of the covering layer. Adhesion to the roller main body can be enhanced by the fact that the first lateral surface of the roller main body is roughened or structured, for example sandblasted, at least in some section or sections and preferably completely.

In a first embodiment, the first edge region and preferably also the second edge region can be folded over around the roller main body itself and fixed thereon, or, in a second embodiment, can be folded over around a further component of the roller and fixed thereon, as described below.

In the first embodiment, in the first end section, preferably also in the second end section, the roller main body has a curvature at the end, around which the first edge region or the second edge region of the covering layer is folded over inwards. The curvature defines a bending radius of the covering layer, around which the covering layer is folded over, thereby avoiding high shear stresses in the covering layer and preserving the fibres of the fibre composite material. At the same time, the roller has as simple a construction as possible with few components.

The curvature initially runs inwards from the first lateral surface in the direction of the longitudinal axis of the roller main body. The curvature preferably extends as far as a fastening section of the roller main body for the respective edge region of the covering layer. The fastening section is preferably straight in an axial cross section and inclined with respect to the longitudinal axis of the roller main body, preferably at an angle of between 2.5° and 60°, more preferably between 5° and 30°.

In this embodiment, the covering layer is supported completely by the roller main body. In other words, the roller main body extends in the longitudinal direction along the entire covering layer with the exception of the first and the second edge region of the covering layer, which are folded over around the first and the second end section of the roller main body.

In the second embodiment, the roller further comprises a first end ring and preferably a second end ring, which are arranged coaxially with respect to the roller main body and adjoin the roller main body at the first and second end section, respectively. The first and the second end ring are flush with the first lateral surface and have, on a side facing away from the roller main body, a curvature around which the first and second edge region, respectively, of the covering layer are folded over inwards. The curvature defines a bending radius of the covering layer, around which the covering layer is folded over, thereby avoiding high shear stresses in the covering layer and preserving the fibres of the fibre composite material. In this way, the curvature and thus the bending radius of the covering layer can be configured independently of the wall thickness of the roller main body, which in turn permits minimization of the wall thickness of the roller main body. The first and the second end ring directly adjoin the free end of the first and second end section, respectively. In the region in which the first and the second end ring are flush with the roller main body, they have an outside diameter which corresponds to the outside diameter of the roller main body or of the first lateral surface.

The curvature initially runs inwards from the outside of the end ring, which adjoins the first lateral surface, in the direction of the longitudinal axis of the roller main body. The curvature preferably runs as far as a fastening section of the respective end ring for the corresponding edge region. The fastening section is preferably straight in an axial cross section and inclined with respect to the longitudinal axis of the roller main body, preferably at an angle of between 2.5° and 60°, more preferably between 5° and 30°.

In this embodiment, the covering layer is supported by the roller main body and by the first and the second end ring. In other words, the roller main body, the first end ring and the second end ring extend in the longitudinal direction along the entire covering layer with the exception of the first and the second edge region of the covering layer, which are folded over around the first and the second end ring.

The first and the second end ring may be formed from aluminium and, independently thereof, may have a surface, in particular in the fastening section, which is roughened or structured in order to improve the adhesion of the covering layer.

The first and the second end section of the roller main body are preferably of tubular shape and have an inside diameter. The first and the second end ring can each have a first section, which is inserted into the first and second end section, respectively, and the outside diameter of which corresponds substantially to the inside diameter of the end sections. At the end of the roller main body, the first and the second end ring extend radially outwards from the first section to a lateral surface section which is arranged flush with the first lateral surface of the roller main body and forms the outer side of the end ring. The curvature extends from the lateral surface section to the fastening section of the respective end ring, which is preferably arranged at least partially or completely in the interior of the roller main body.

In order to fix the first edge region frictionally, the roller preferably comprises at least one first clamping element. The roller preferably further comprises a second clamping element. The first and the second clamping element preferably press the first and second edge region, respectively, of the covering layer against the fastening section of the roller main body or of the first and second end ring, respectively, thereby fixing the covering layer.

In the first embodiment described above, the first clamping element and the first end section of the roller main body preferably have corresponding conical contact surfaces, between which the first edge region is accommodated. Similarly, the second clamping element and the second end section of the roller main body can have corresponding conical contact surfaces, between which the second edge region is accommodated. The conical contact surfaces of the roller main body in the first and second end sections are preferably formed by the fastening sections of the roller main body.

In the second embodiment described above, the first clamping element and the first end ring can have corresponding conical contact surfaces, between which the first edge region is accommodated. Similarly, the second clamping element and the second end ring can have corresponding conical contact surfaces, between which the second edge region is accommodated. The conical contact surfaces of the first and second end rings are preferably formed by the fastening sections of the respective end ring.

The first and the second edge region can rest directly against the respective contact surfaces in order to enable direct force transmission. By virtue of the conical shape, high normal forces can be transmitted to the first and the second edge region without significant shear stresses acting on the fibres of the fibre composite material.

In a preferred embodiment, the first clamping element is adjustable in the longitudinal direction of the roller in such a way that a contact pressure acting on the first edge region of the covering layer by means of the first clamping element can be set. This preferably also applies to the second clamping element. For example, the first and the second clamping element can be screwed to a further component of the roller, for example a roller base, allowing the contact pressure to be varied by means of the screw fastening.

The first and the second clamping element are annular or disc-shaped, for example, and are arranged coaxially with respect to the roller main body, in particular on the first and second end sections thereof. If the first and the second end section are of tubular shape and/or if the first and the second end ring are used, the first and the second clamping element are preferably arranged radially inside the roller main body or the first and the second end ring, respectively.

In general, the roller can have a first roller base and a second roller base. The roller bases are substantially annular or disc-shaped and can be formed integrally with the roller main body or as separate elements.

The roller can furthermore comprise a first and a second shaft journal, which are configured to support the roller in rotation. For this purpose, the first and the second shaft journal are arranged coaxially with respect to the roller main body. The first and the second roller journal can, in turn, be formed integrally with the first and second roller base, respectively, or can be separate elements.

If the first and the second shaft journal are formed integrally with the first and the second roller base, respectively, the first and the second roller base are preferably formed separately from the roller main body and are centred with respect to the latter. For example, the roller main body is a hollow shaft and is in each case conical in the first and second end sections, wherein the first and the second roller base have a corresponding conical shape.

If the first and the second shaft journal are separate elements, the first and the second roller base each have a through-opening in the longitudinal direction of the roller main body, in which opening the first and the second shaft journal, respectively, are mounted. In order to centre the first and the second shaft journal relative to the roller main body, the through-opening in the first and in the second roller base is preferably conically shaped, and the first and the second shaft journal each have a conically shaped end which is accommodated in the through-opening of the respective roller base. In this embodiment, the first and the second roller base are preferably of substantially cylindrical shape and are accommodated in the first and second end section, respectively, of the roller main body, for example being pressed into the latter.

It is conceivable for the first and the second roller base to simultaneously form the first and second clamping element, respectively, and to fix the covering layer in relation to the roller main body. Preferably, however, the first and the second clamping element are formed separately and are screwed to the first and the second roller base, respectively, the screws being distributed over the circumference of the first and the second clamping element in order to bring about a uniform contact pressure on the first and the second edge region of the covering layer. The first and the second clamping element can each have centrally a through-opening through which the first and second shaft journal, respectively, extend.

In principle, there is a preference for the first roller base to be accommodated in the first end section of the roller main body, for the second roller base to be accommodated in the second end section of the roller main body, and for the first and the second roller base to be clamped together in the longitudinal direction of the roller main body by means of a clamping device. The axial clamping advantageously contributes to minimizing the thermal expansion of the roller main body and thus reduces the risk of delamination of the covering layer from the roller main body.

The clamping device can, for example, comprise a rod which is arranged coaxially with respect to the roller main body and extends from one end of the roller to the other end of the roller through the shaft journals, the roller bases and the roller main body. At least at one end of the rod, preferably at both ends, a threaded section with a nut is provided, by means of which the tension can be set when the other end of the rod is locked. The rod can be made of steel, for example.

In an alternative embodiment, the clamping device comprises carbon fibre filaments, which are preferably attached to the roller bases or shaft journals by hooking in loops.

In order to fix the first and the second edge region of the covering layer reliably and not to damage them, they should be folded over inwards without folds and without overlaps and should preferably be clamped. For this purpose, it is advantageous if the first edge region and the second edge region each have a plurality of notches distributed in the circumferential direction. Each notch of the plurality of notches is configured in such a way, starting from an edge of the covering layer which runs in the circumferential direction, that the first and the second edge region are formed without folds and two subsections of the first and second edge region, respectively, which are separated from one another by a notch of the plurality of notches, do not overlap. This can be achieved, for example, in that each notch of the plurality of notches is tapered, for example substantially triangular, starting from the respective edge.

The roller has an outer second lateral surface, which is formed at least partially by the covering layer. The second lateral surface can be understood to be the useful surface of the roller. If the roller forms, for example, a deflection roller in a crosslapper, the second lateral surface forms the contact surface with the deflected conveyor belt. If the roller is used in a carding machine, a set of teeth can be provided on the second lateral surface.

The covering layer preferably extends in the longitudinal direction of the roller over at least 50%, more preferably over at least 70%, even more preferably over at least 80%, of the second lateral surface. The covering layer can also completely form the second lateral surface, i.e. it can extend in the longitudinal direction over 100% of the second lateral surface. The latter is conceivable, for example, in the case of deflection rollers. In the case of rollers of a carding machine, a region which is not formed by the covering layer and serves to fasten a wire which forms the set is preferably provided at both axial ends of the second lateral surface. These end regions of the second lateral surface can be formed by the first and the second clamping element or the first and the second roller base.

The roller main body is preferably formed from metal, in particular from aluminium or steel, or from a plastic, in particular from GRP (glass-reinforced plastic) or polyamide. Compared with rollers which are formed entirely from a fibre composite material, this results in a cost reduction while nevertheless providing sufficient resistance to bending.

The roller main body preferably has a wall thickness of between 1 mm and 50 mm, more preferably between 1 mm and 30 mm, even more preferably between 1 mm and 10 mm. Owing to the design of the roller main body as a hollow shaft with a small wall thickness, the roller has a low mass.

The covering layer preferably comprises carbon fibres, glass fibres or mineral fibres, such as ceramic fibres or silicate fibres, and a matrix of plastic, in particular of resins of epoxy, polyester, polyurethane or melamine.

The covering layer preferably has a layer thickness of between 0.1 mm and 10 mm, more preferably between 0.5 mm and 8 mm, even more preferably between 1 mm and 5 mm.

The ratio of the wall thickness of the roller main body to the layer thickness of the covering layer can be varied in a simple manner in order to set the properties of the roller.

The roller can have a length in the longitudinal direction which is between 1.0 m and 18.0 m, preferably between 2.0 m and 18.0 m, more preferably between 4.0 m and 18.0 m. An outside diameter of the roller can be between 50 mm and 800 mm, preferably between 80 mm and 400 mm, even more preferably between 100 mm and 350 mm. With these dimensions, the above-described advantages in respect of cost reduction, combined with sufficient resistance to bending, while avoiding delamination of the covering layer from the roller main body, are particularly evident.

The advantages of a relatively low mass have an advantageous effect, particularly also at high rotational speeds and/or accelerations of the roller. The roller can therefore preferably be operated at a peripheral speed which is between 30 m/min and 6,000 m/min, more preferably between 100 m/min and 5,500 m/min, even more preferably between 400 m/min and 5,000 m/min. Particularly high peripheral speeds of up to 3,500 m/min or 5,000 m/min are achieved, for example, in the case of random rollers at the card outlet or in the case of knock-off rollers in aerodynamic nonwoven formation.

According to another aspect of the invention, a crosslapper comprises at least one conveyor belt for conveying a fibrous batt web and a plurality of deflection rollers, around which the at least one conveyor belt is guided, wherein at least one deflection roller of the plurality of deflection rollers is formed by a roller as described herein. As described at the outset, it is important, particularly in the case of crosslappers, that the deflection rollers are dimensionally stable, despite high loading, and have a low mass on account of the high accelerations to which they may be subjected. This can be achieved at relatively low cost by such a roller. All the features described herein in respect of the roller itself can apply analogously when used in a crosslapper.

In the crosslapper, the roller is rotatably mounted and subjected to high speeds and accelerations. For example, the at least one conveyor belt is moved over the roller at a speed which is between 100 m/min and 1,000 m/min, preferably between 200 m/min and 900 m/min, even more preferably between 400 m/min and 700 m/min.

In a preferred embodiment, the crosslapper comprises a feed belt, at least a first conveyor belt and a second conveyor belt, an upper carriage and a laying carriage, and a draw-off belt. The feed belt is configured to feed a fibrous batt web coming from a carding machine to the crosslapper and to transfer it to the first conveyor belt. The first conveyor belt conveys the fibrous batt web to the upper carriage, in which the fibrous batt web is deflected. The fibrous batt web is transferred from the upper carriage to the second conveyor belt. The second conveyor belt conveys the fibrous batt web to the laying carriage, wherein the fibrous batt web can be covered by the first conveyor belt between the upper carriage and the laying carriage. The laying carriage is configured to move back and forth perpendicularly to the conveying direction of the draw-off belt and in the process to deposit the fibrous batt web on the draw-off belt. The at least one conveyor belt can comprise at least one or more of the first conveyor belt, the second conveyor belt, any further conveyor belts provided, the feed belt and the draw-off belt.

According to another aspect of the invention, a carding machine for producing a fibrous batt web comprises a main cylinder (also called a main roller) and a plurality of engagement rollers, wherein each engagement roller of the plurality of engagement rollers is configured for engagement with fibre material and is associated with the main cylinder, upstream or downstream thereof, wherein at least one engagement roller of the plurality of engagement rollers is formed by a roller as described herein. For this purpose, the engagement roller has a set of teeth, which is provided on the second lateral surface of the roller. Advantageously, the set can be formed by a wire which has a plurality of teeth, is wound around the second lateral surface of the roller and is connected, for example brazed, to the second lateral surface in at least one end region, preferably in two end regions thereof.

If the roller is configured, for example, as a random roller at an outlet of the carding machine, it can be configured for peripheral speeds of up to 3,500 m/min.

According to another aspect of the invention, a needling machine for consolidating a fibrous batt web comprises a needling zone having at least one needle bar having a multiplicity of needles and is configured to consolidate the fibrous batt web. This needling machine comprises a plurality of rollers for guiding the nonwoven web which is to be consolidated or has been consolidated, such as, for example, feed or draw-off rollers, wherein at least one roller of the plurality of rollers is formed by a roller as described herein.

The plurality of rollers of the needling machine is generally operated at low speeds. Owing to the large span which has to be bridged in the needling machine, rollers have hitherto frequently required intermediate support in order to minimize or eliminate the sagging of the rollers, thereby increasing the complexity of the machine and the costs thereof. Using rollers according to the invention, which can have a higher resistance to bending than conventional rollers with the same dimensions, in the needling machine, it is possible to dispense with intermediate support for the rollers.

According to another aspect of the invention, an aerodynamic nonwoven-forming system is provided, wherein at least one roller, in particular the knock-off roller, can be formed by a roller as described herein.

According to another aspect of the invention, a drafting arrangement comprises a plurality of rollers for stretching the fibrous batt or nonwoven web, wherein at least one roller of the plurality of rollers is formed by a roller as described herein. The drafting arrangement can be provided upstream and/or downstream of a crosslapper, likewise after a consolidating device such as a needling machine.

In addition to the fields of use already mentioned, there are also many other applications for the roller described herein. Most of them relate in general to machines that convey and/or process material webs or pieces of material. Use of the roller in machines which transport and/or process web-like products with a high degree of thickness precision is particularly preferred.

The use of such a roller in situations where long, thin rollers are used and high requirements are placed on great stiffness (low sag) under high line loads, that is to say precise gap dimensions must be maintained, is likewise particularly advantageous. Primarily, this relates to rollers that run at high velocities, or rotational speeds. The relatively low weight of such a roller is particularly advantageous here.

Specific further examples for the use of this roller are other textiles machines (e.g. calendars) for calibrating, laminating, pressing, embossing, patterning, ironing; plastics machines for films, for example for laminating and embossing; printing machines and coating machines; machines for leather production and leather finishing; machines for woodworking and veneer production; rolling mills for metals and paper pressing plants, etc.

### BRIEF DESCRIPTION OF THE DRAWINGS

FIG. 1 shows an embodiment of a roller according to the invention in a cross-sectional view;

FIGS. 2a, b show two alternatives of an embodiment of a roller according to the invention in a detail view;

FIGS. 3a, b show two alternatives of another embodiment of a roller according to the invention in a detail view;

FIG. 4 shows schematically an edge region of a covering layer of an embodiment of a roller according to the invention in a perspective view;

FIG. 5 shows schematically an embodiment of a crosslapper according to the invention in a side view; and

FIG. 6 shows schematically an embodiment of a carding machine according to the invention in a side view.

### DETAILED DESCRIPTION OF SPECIFIC EMBODIMENTS

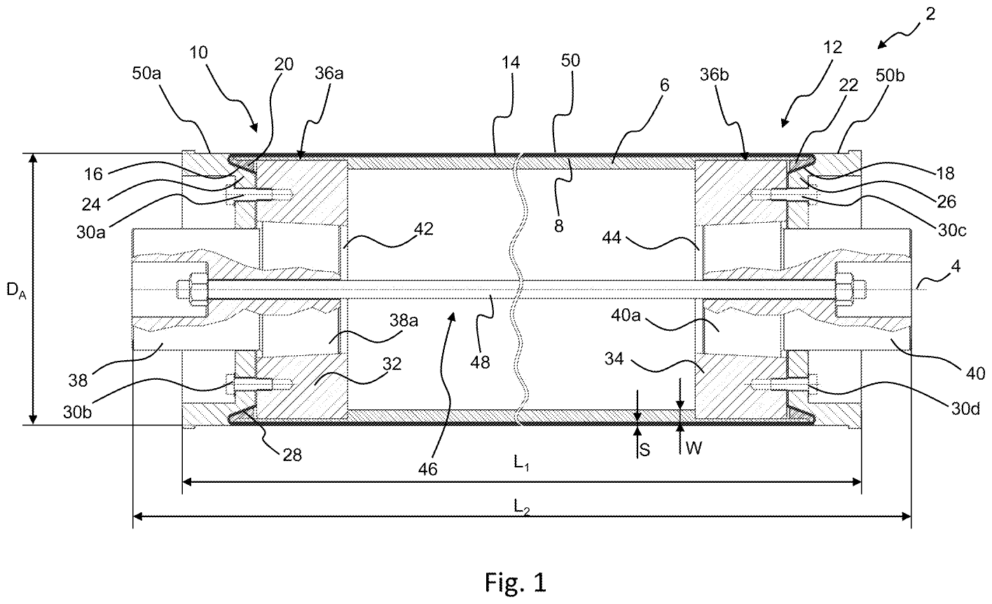

FIG. 1 illustrates one embodiment of a roller 2 according to the invention in a cross-sectional view along the longitudinal axis 4 of roller 2. Roller 2 comprises a substantially cylindrical roller main body 6, which is preferably a hollow shaft. This does not necessarily have to be the case, but it is advantageous if roller main body 6 is of tubular shape at least at its ends. Roller main body 6 has an outer first lateral surface 8, a first end section 10 and a second end section 12. First and the second end section 10, 12 are each arranged at one end of roller main body 6 and lie opposite one another in the longitudinal direction. Roller main body 6 has a wall thickness W and is preferably formed from a metal, such as steel or aluminium, or a plastic.

Roller 2 further comprises a covering layer 14 made of a fibre composite material, which preferably comprises carbon fibres and a polyester resin as a matrix and, irrespective of the materials used, has a layer thickness S. By virtue of this construction, roller 2 has a high resistance to bending while having a low mass. The covering layer 14 completely surrounds first lateral surface 8 in the circumferential direction of roller main body 6 and also preferably extends completely along first lateral surface 8 in the longitudinal direction of roller main body 6. As a result, first lateral surface 8 of roller main body 6 is completely covered by covering layer 14. An outside diameter of roller 2 is designated by the reference sign DA.

A first edge region 16 of covering layer 14 extends beyond first end section 10 of roller main body 6, is folded over inwards and is fixed in relation to roller main body 6. In the embodiment illustrated, roller 2 is of symmetrical construction and, as a result, is of similar design at both ends. However, this need not necessarily be the case, and the two ends of roller 2 can also be of different designs.

A second edge region 18 of covering layer 14 extends beyond second end section 12 of roller main body 6, is folded over inwards and is fixed in relation to roller main body 6.

The fibre composite material of the covering layer 14 generally comprises fibres which are wound in the form of a woven fabric, a non-crimp fabric or in the form of prepregs in one or more plies around roller main body 6 and are then folded over or turned over inwards, that is to say in the direction of longitudinal axis 4, in the first and in the second end section 10, 12.

In this context, a first portion of fibres of the fibre composite material runs substantially in the circumferential direction of roller main body 6 and a second portion of fibres of the fibre composite material runs substantially in the longitudinal direction of roller main body 6. By virtue of the fact that covering layer 14 is folded over in the first and in the second end section 10, 12 and is fixed in relation to roller main body 6, covering layer 14 counteracts thermal expansion of roller main body 6 both in the radial direction and in the longitudinal direction, and delamination of covering layer 14 from roller main body 6 can be avoided.

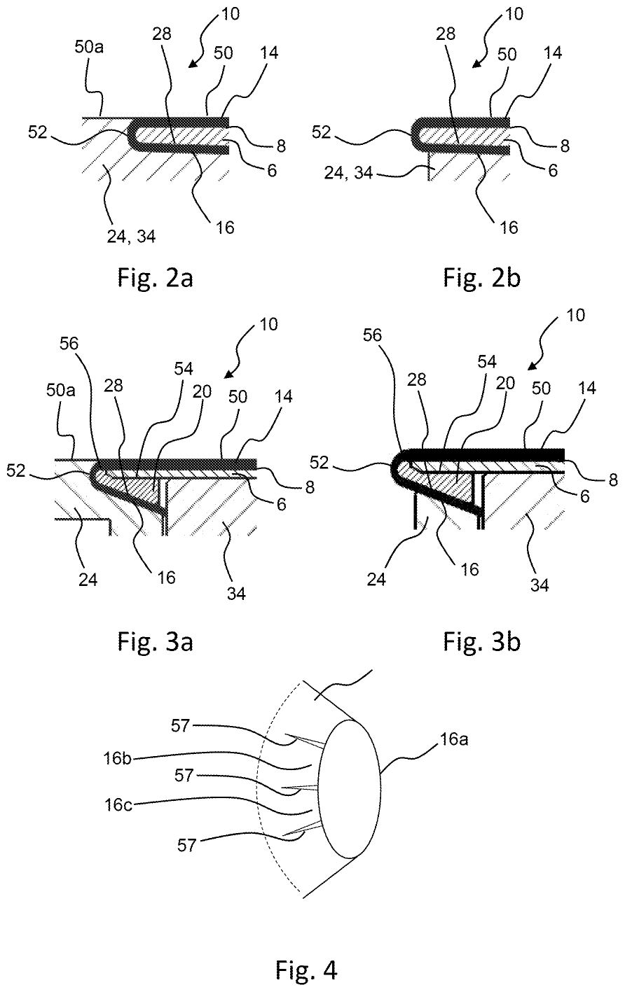

In order to avoid shear stresses in covering layer 14, the first and the second edge region 16, 18 are folded over inwards around a curvature. In a first embodiment, roller main body 6 has a corresponding curvature in each case at the ends in the first and in the second end section 10, 12, as described in more detail with reference to FIGS. 2a and 2b. In a second embodiment, roller 2 comprises at least one first end ring 20 and preferably also a second end ring 22, as shown in FIG. 1 and described in more detail with reference to FIGS. 3a and 3b. The first and the second end ring 20, 22 then each have the curvature around which edge regions 16, 18 are folded over. The following statements apply both to the first and to the second embodiment, unless described otherwise.

Covering layer 14 can be adhesively fixed both in the first and in the second edge region 16, 18 and in the region of first lateral surface 8 of roller main body 6. For this purpose, the resin of the fibre composite material of covering layer 14 and/or a separate adhesive can be used. In addition or as an alternative, covering layer 14 can be fixed by frictional engagement in first edge region 16 and preferably also in second edge region 18.

In the embodiment illustrated, the roller 2 comprises a first clamping element 24 and preferably a second clamping element 26. The first clamping element 24 fixes the first edge region 16 of the covering layer 14 by frictional engagement and the second clamping element 26 fixes the second edge region 18 by frictional engagement. The first and the second clamping element 24, 26 press the first and the second edge region 16, 18, respectively, against a fastening section 28 of the roller main body 6 (see FIG. 2a, b) or, as here, of the first or second end ring 20, 22 (see FIG. 3a, b). The first and the second clamping element 24, 26 are preferably annular or disc-shaped and are arranged coaxially with respect to the longitudinal axis 4 of the roller main body 6, preferably in each case at one end of the roller 2. If the first and the second end section 10, 12 are of tubular shape or if the roller main body 6 is configured as a hollow shaft, as illustrated, the first and the second clamping element 24, 26 are preferably accommodated at least partially in the first and second end section 10, 12, respectively, of the roller main body 6.

The contact pressure on the first and the second edge region 16, 18 can be set by virtue of the adjustability of the first and the second clamping element 24, 26 in the longitudinal direction of the roller main body 6. This can be achieved by screwing the first and the second clamping element 24, 26 to a further component of the roller 2, allowing the contact pressure to be varied by means of the screw fastening. The longitudinal axes of the screws 30a-d are preferably aligned parallel to the longitudinal axis 4 of the roller main body 6, and the screws 30a-d of each clamping element 24, 26 are distributed over the circumference.

In general, the roller 2 can also have a first roller base 32 and a second roller base 34. The first and the second roller base 32, 34 each form a base of the substantially cylindrical roller main body 6, with the first roller base 32 being arranged in the first end section 10 and the second roller base 34 being arranged in the second end section 12. The first and the second clamping element 24, 26 can then be screwed to the respective roller base 32, 34, as already described.

The first and the second roller base 32, 34 can be formed integrally with the roller main body 6 or, as illustrated, can be provided as separate elements. In this case, the first and the second roller base 32, 34 are substantially annular or disc-shaped, and thus have a cylindrical shape, and are arranged coaxially with respect to the roller main body 6. An outside diameter of the first and the second roller base 32, 34 corresponds substantially to the inside diameter of the roller main body 6 in the first and the second end section 10, 12. In each of the two end sections 10, 12, the roller main body 6 can have a seat 36a, b for receiving the respective roller base 32, 34. Each seat 36a, b comprises an inner circumferential surface of the roller main body 6 in the first and the second end section 10, 12, respectively, as well as a stop surface, which positions the first and the second roller base 32, 34 in the longitudinal direction of the roller main body 6. The stop surface is formed, for example, by a step on the inner side of the roller main body 6, the roller main body 6 having a larger inside diameter on the side of the step facing the respective end than on the other side of the step.

The roller 2 can furthermore comprise a first shaft journal 38 and a second shaft journal 40, which are configured to support the roller 2 in rotation. For this purpose, the first and the second shaft journal 38, 40 are arranged coaxially with respect to the roller main body 6. The first and the second roller journal 38, 40 can, in turn, be formed integrally with the first and second roller base 32, 34, respectively, or can be separate elements.

Shaft journals 38, 40 formed as separate elements are to be centred with respect to the roller main body 6 in order to ensure the concentricity of the roller 2. In the embodiment illustrated, the first and the second roller base 32, 34 each have a through-opening 42, 44 in the longitudinal direction of the roller main body 6, in which the first and the second shaft journal 38, 40 are mounted. The through-openings 42, 44 are conically shaped and the first and the second shaft journal 38, 40 each have a corresponding, conically shaped end 38a, 40a, which is accommodated in the respective through-opening 42, 44. The first and the second clamping element 24, 26 likewise have a through-opening, through which the respective shaft journal 38, 40 passes.

A (temperature-induced) expansion of the roller 2 or of the roller main body 6 can be further counteracted by the first and the second roller base 32, 34 being clamped together in the longitudinal direction of the roller main body 6 by means of a clamping device 46. As illustrated, the clamping device 46 can comprise a rod 48, for example made of steel, and can be arranged coaxially with respect to the roller main body 6. For clamping, the rod 48 has a respective lock nut to the outside of the roller bases 32, 34 in the longitudinal direction. Here, the rod 48 extends through the first shaft journal 38, the first roller base 32, the roller main body 6, the second roller base 34 and the second shaft journal 40 coaxially with respect to the longitudinal axis 4 and has a threaded section at each of its two ends. A nut is screwed onto each of these threaded sections and bears against the respective shaft journal 38, 40.

As can be seen in FIG. 1, the roller 2 has an outer lateral surface 50, which is also referred to as the second lateral surface 50 to better distinguish it from the first lateral surface 8 of the roller main body 6. In the majority of cases and in some embodiments, the second lateral surface 50 is formed completely by the covering layer 14. For example, the covering layer 14 extends over at least 80% or at least 90% of the length L₁ of the second lateral surface 50 in the longitudinal direction of the roller 2. The length of the overall roller 2 is designated as L₂ and depends on the length of the shaft journals 38, 40 and thus on the mounting of the roller 2 in the respective machine. For the present consideration, the length L₁ of the second lateral surface 50 is therefore of greater importance.

The second lateral surface 50 forms the actual useful surface of the roller 2. If the roller 2 is used, for example, as a deflection roller for a conveyor belt, for example in a crosslapper, the second lateral surface 50 forms the contact surface with the conveyor belt. If the roller 2 is used in a carding machine, a set of teeth can be provided on the second lateral surface 50. The set of teeth is usually formed by winding a wire around the roller 2, which wire is to be fastened to the roller ends. In this case, it is therefore advantageous if a first and a second end region 50a, 50b of the second lateral surface 50 are not formed by the covering layer 14. On the contrary, the first and the second end region 50a, 50b can be formed by the first and second clamping element 24, 26, or the first and second roller base 32, 34, respectively.

FIGS. 2a, 2b, 3a, 3b each show a detail view of the first end section 10 of different embodiments of the roller 2. All statements in this regard apply mutatis mutandis to the second end section 12.

FIGS. 2a and 2b relate to the first embodiment, in which the covering layer 14 is folded over around the first end section 10 of the roller main body 6 itself, which has the curvature 52. From the first lateral surface 8, the curvature 52 initially runs inwards in the direction of the longitudinal axis 4 of the roller main body 6 and as far as the fastening section 28 of the roller main body 6 for the first edge region 16. In the cross-sectional view, the fastening section 28 is preferably of straight design and inclined with respect to the longitudinal axis 4, and it therefore provides a substantially conical contact surface for the first edge region 16 of the covering layer 14 and is preferably arranged in the interior of the roller main body 6.

In the exemplary embodiment according to FIG. 2a, the first end region 50a of the second lateral surface 50 is formed by the first clamping element 24 or the first roller base 34, which are arranged flush with the covering layer 14, thus ensuring that a second lateral surface 50 which is as free of disruptions as possible is formed. The first clamping element 24 or the first roller base 34 can have a groove which corresponds to the curvature 52 and rests against the folded over part of the covering layer 14.

In the exemplary embodiment according to FIG. 2b, no end region 50a, b of the second lateral surface 50 is provided next to the covering layer 14. The second lateral surface 50 is formed completely by the covering layer 14. The first clamping element 24 and the first roller base 32 are at least partially and preferably completely accommodated in the roller main body 6.

FIGS. 3a and 3b relate to the second embodiment, in which the covering layer 14 is folded over around the first end ring 20, which has the curvature 52. The first end ring 20 is arranged coaxially with respect to the roller main body 6 and, at the first end section 10, directly adjoins the roller main body 6 at the end. The first end ring 20 is flush with the first lateral surface 8, and thus has an outside diameter which corresponds to the outside diameter of the roller main body 6 or first lateral surface 8.

In the embodiment illustrated, the first end ring 20 has a first section 54, which is inserted into the first end section 10 of the roller main body 6, an outside diameter of the first section 54 corresponding substantially to the inside diameter of the roller main body 6 in the first end section 10. At the end of the roller main body 6, the first end ring 20 extends radially outwards to a lateral surface section 56 of the first end ring 20, which is arranged flush with the first lateral surface 8 of the roller main body 6, that is to say has the same outside diameter as the latter. The curvature 52 extends from the lateral surface section 56 as far as the fastening section 28, which in the cross-sectional view is preferably of straight design and inclined with respect to the longitudinal axis 4 of the roller main body 6, with the result that it provides a substantially conical contact surface for the first edge region 16 of the covering layer 14.

In the exemplary embodiment according to FIG. 3a, the first end region 50a of the second lateral surface 50 is provided in a manner analogous to the exemplary embodiment according to FIG. 2a. In the exemplary embodiment according to FIG. 3b, analogously to the exemplary embodiment according to FIG. 2b, no end region 50a, b of the second lateral surface 50 is provided, and therefore the second lateral surface 50 is formed completely by the covering layer 14.

FIG. 4 shows schematically the folded-over first edge region 16 in a perspective view. As a result of the folding over of the first edge region 16, a substantially encircling first edge 16a of the covering layer 14 is arranged radially inside the first lateral surface 8. As a result, the first edge 16a has a smaller diameter and a smaller circumference than the part of the covering layer 14 which is arranged on the first lateral surface 8. This applies analogously to a second edge of the covering layer 14 in the second edge region 18. However, in order to reliably clamp the first and, if appropriate, also the second edge region 16, 18, the respective edge region 16, 18 should be configured to be free of folds and should have no overlaps of the covering layer material.

The first edge region 16 and preferably also the second edge region 18 can therefore have a plurality of notches 57 distributed in the circumferential direction. Each notch 57 of the plurality of notches 57 is configured in such a way, starting from the first edge 16a or from the second edge of the covering layer 14, that the respective edge region 16, 18 is folded over inwards without folds and without overlaps. Consequently, two subsections 16b, 16c, which are separated from one another by a notch 57, do not overlap. For this purpose, the notches 57 can be tapered, for example substantially triangular, starting from the respective edge 16a.

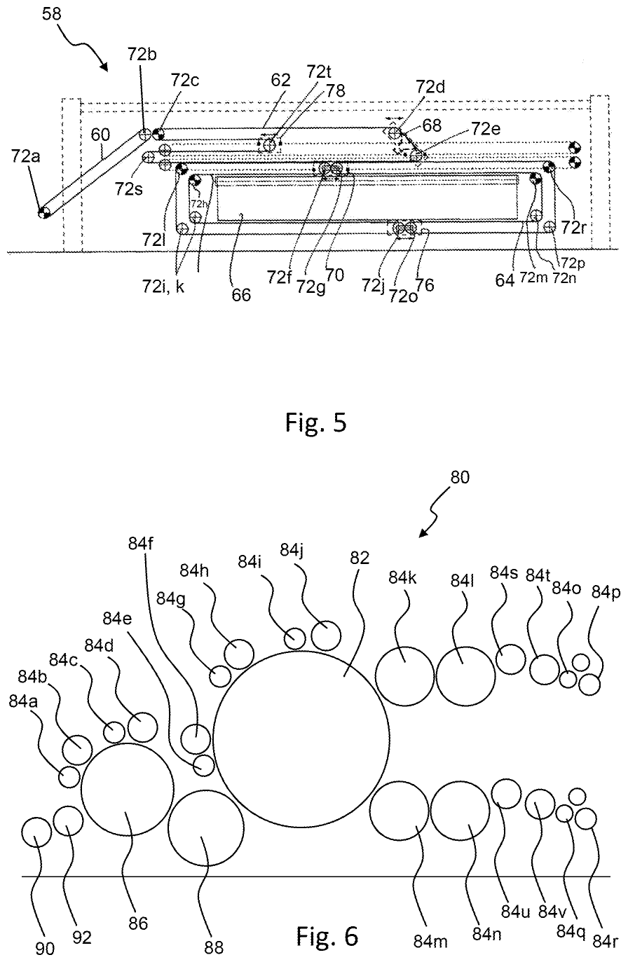

FIG. 5 schematically illustrates a crosslapper 58 in a side view. The crosslapper 58 comprises at least one conveyor belt for conveying a fibrous batt web (not illustrated), here a feed belt 60, a first conveyor belt 62, a second conveyor belt 64 and a draw-off belt 66. Furthermore, the crosslapper 58 preferably comprises an upper carriage 68 and a laying carriage 70. The feed belt 60 is configured to feed a fibrous batt web coming from a carding machine to the crosslapper 58 and to transfer it to the first conveyor belt 62. The first conveyor belt 62 conveys the fibrous batt web to the upper carriage 68, in which the fibrous batt web is deflected. The fibrous batt web is then transferred from the first conveyor belt 62 to the second conveyor belt 64. The second conveyor belt 64 conveys the fibrous batt web to the laying carriage 70. The laying carriage 70 is configured to move back and forth perpendicularly to the conveying direction of the draw-off belt 66, which is aligned perpendicularly to the plane of the drawing, and in the process to deposit the fibrous batt web on the draw-off belt 66.

The crosslapper 58 comprises a plurality of deflection rollers 72a-t, around which the at least one conveyor belt 60, 62, 64 is guided, wherein at least one deflection roller 72a-t of the plurality of deflection rollers 72a-t is formed by the roller 2, as described herein. All the conveyor belts 60, 62, 64 are configured to circulate and are each driven by at least one of the deflection rollers.

More precisely, in the illustrated embodiment, the feed belt 60 is guided around a first and a second deflection roller 72a, 72b. Adjacent to the feed belt 60, the first conveyor belt 62 preferably runs around a third deflection roller 72c and onwards from there to the upper carriage 68, in which the first conveyor belt 62 is deflected around a fourth and a fifth deflection roller 72d and 72e. It is preferable if both the first and the second conveyor belt 62, 64 lead from the upper carriage 68 to the laying carriage 70. A third conveyor belt 74 can be provided, which likewise leads from the other side to the laying carriage 70. In the laying carriage 70, the second and, if present, the third conveyor belt 64, 74 or alternatively the first and the second conveyor belt 62, 64 are wrapped around a sixth deflection roller 72f and a seventh deflection roller 72g, respectively, between which a laying gap is formed for discharging the fibrous batt web onto the draw-off belt 66. The third conveyor belt 74 first leads from the laying carriage 70 via a plurality of deflection rollers 72h-1 via the draw-off belt 66 and back to the laying carriage 70, an eighth deflection roller 72j being rotatably mounted in a first auxiliary carriage 76. The first auxiliary carriage 76 is provided for the length compensation of the second and the third conveyor belts 64, 74 and can be moved in the opposite direction to the laying carriage 70. The second conveyor belt 64 leads from the laying carriage 70 firstly via the draw-off belt 66 and via a plurality of deflection rollers 72m-r back to the laying carriage 70, a ninth deflection roller 72o likewise being rotatably mounted in the first auxiliary carriage 76. The first conveyor belt 62 runs from the upper carriage 68, via a tenth and an eleventh deflection roller 72s, 72t, back to the feed belt 60, the eleventh deflection roller 72t being rotatably mounted in a second auxiliary carriage 78. The second auxiliary carriage 78 is provided for the length compensation of the first conveyor belt 62. The roller described can also be used in all other known configurations of crosslappers.

FIG. 6 schematically illustrates a side view of a carding machine 80 for producing a batt web or a preliminary batt. The carding machine 80 is configured, in particular, for producing a fibrous batt web from a fibre flock mat. For this purpose, the carding machine 80 comprises a main cylinder 82, also referred to as a main roller, and a plurality of engagement rollers 84a-v, 86, 88, 90, 92, which are configured for engagement with fibre material, are associated with the main cylinder 82, upstream or downstream thereof, and of which at least one engagement roller is formed by a roller 2, as described herein.

The plurality of engagement rollers 84a-v, 86, 88, 90, 92 of the carding machine 80 may comprise, for example, a licker-in 86 and a transfer roller 88 ahead of the main cylinder 82 as well as a take-in roller 90 and a breast roller 92. The plurality of engagement rollers 84a-j can comprise a plurality of clearer and working rollers 84a-j, which are each arranged in pairs along the circumference of the main cylinder 82 and/or of the licker-in 86. The plurality of engagement rollers 84k-n can also comprise upper or lower random rollers 84k,m and/or doffer rollers 84l,n, which are provided downstream of the main cylinder 82, or upper and lower draw-off rollers 84o-r arranged downstream of the latter. Finally, the plurality of engagement rollers can comprise at least one upper and/or lower compression roller 84s-v. For example, a first and a second upper compression roller 84s,t are provided between the upper doffer roller 84l and the upper draw-off roller 84o. A first and a second lower compression roller 84u,v can furthermore be provided between the lower doffer roller 84n and the lower draw-off roller 84q.

1. A roller comprising a substantially cylindrical roller main body having an outer first lateral surface, a first end section and a second end section, which lies opposite the first end section in a longitudinal direction of the roller main body; and a covering layer made of a fibre composite material; wherein the covering layer completely surrounds the first lateral surface of the roller main body in a circumferential direction of the roller main body; and wherein a first edge region of the covering layer extends beyond the first end section of the roller main body, is folded over inwards and is fixed in relation to the roller main body.

2. The roller according to claim 1 wherein the first edge region is fixed adhesively and/or frictionally.

3. The roller according to claim 1 wherein the first end section of the roller main body has, at an end, a curvature which starts from the first lateral surface and around which the first edge region of the covering layer is folded over inwards.

4. The roller according to claim 1 wherein the roller further comprises a first end ring, which is arranged coaxially with respect to the roller main body and adjoins the roller main body at the first end section, wherein the first end ring is flush with the first lateral surface and has, on a side facing away from the roller main body, a curvature around which the first edge region of the covering layer is folded over inwards.

5. The roller according to claim 3 wherein the roller comprises at least one first clamping element, which fixes the first edge region, wherein the first clamping element is annular or disc-shaped and is arranged coaxially with respect to the roller main body.

6. The roller according to claim 4 wherein the roller comprises at least one first clamping element, which fixes the first edge region, wherein the first clamping element is annular or disc-shaped and is arranged coaxially with respect to the roller main body.

7. The roller according to claim 5 wherein the first clamping element and the first end section of the roller main body have corresponding conical contact surfaces, between which the first edge region is accommodated.

8. The roller according to claim 6 wherein the first clamping element and the first end ring have corresponding conical contact surfaces, between which the first edge region is accommodated.

9. The roller according to claim 6 wherein the first clamping element is adjustable in the longitudinal direction of the roller to set a contact pressure acting on the first edge region of the covering layer by means of the first clamping element.

10. The roller according to claim 1 wherein the roller main body is of tubular shape at least in the first end section, and the first edge region is arranged in an interior of the first end section.

11. The roller according to claim 10 wherein the roller comprises a first roller base and a second roller base, wherein the first roller base is accommodated in the first end section of the roller main body, and the second roller base is accommodated in the second end section of the roller main body, wherein the first and the second roller bases are clamped together in the longitudinal direction of the roller main body by a clamping device.

12. The roller according to claim 1 wherein the first edge region of the covering layer has a plurality of notches distributed in the circumferential direction, wherein each notch of the plurality of notches is formed in such a way, starting from an edge of the covering layer which runs in the circumferential direction, that the first edge region is formed without folds and two subsections of the first edge region which are separated from one another by a notch of the plurality of notches do not overlap.

13. The roller according to claim 1 wherein the roller has an outer second lateral surface which is formed at least partially by the covering layer, wherein the covering layer extends in the longitudinal direction of the roller over at least 50% of the second lateral surface.

14. The roller according to claim 1 wherein the roller main body is formed from metal, or from GRP or polyamide.

15. The roller according to claim 14 wherein the covering layer comprises carbon fibres, glass fibres or mineral fibres, and a matrix of plastic.

16. The roller according to claim 15 wherein the matrix of plastic is a matrix of resins of epoxy, polyester, polyurethane or melamine.

17. A crosslapper having at least one conveyor belt for conveying a fibrous batt web and a plurality of deflection rollers, around which the at least one conveyor belt is guided, wherein at least one deflection roller of the plurality of deflection rollers is configured as a roller comprising:
a substantially cylindrical roller main body having an outer first lateral surface, a first end section and a second end section, which lies opposite the first end section in a longitudinal direction of the roller main body; and
a covering layer made of a fibre composite material;
wherein the covering layer completely surrounds the first lateral surface of the roller main body in a circumferential direction of the roller main body; and
wherein a first edge region of the covering layer extends beyond the first end section of the roller main body, is folded over inwards and is fixed in relation to the roller main body.

18. A carding machine for producing a fibrous batt web, the carding machine comprising a main cylinder and a plurality of engagement rollers, wherein each engagement roller of the plurality of engagement rollers is configured for engagement with fibre material and is associated with the main cylinder, upstream or downstream thereof, wherein at least one engagement roller of the plurality of engagement rollers is configured as a roller comprising a substantially cylindrical roller main body having an outer first lateral surface, a first end section and a second end section, which lies opposite the first end section in a longitudinal direction of the roller main body; and
a covering layer made of a fibre composite material;
wherein the covering layer completely surrounds the first lateral surface of the roller main body in a circumferential direction of the roller main body; and
wherein a first edge region of the covering layer extends beyond the first end section of the roller main body, is folded over inwards and is fixed in relation to the roller main body.
